(19) United States
(12) Patent Application Publication
(10) Pub. No.: US 2026/0005298 A1
(43) Pub. Date: Jan. 1, 2026

(54) CATIONIC POLYMER ELECTROLYTES AND PREPARATION METHOD OF THE SAME

(71) Applicant: UIF (UNIVERSITY INDUSTRY FOUNDATION), YONSEI UNIVERSITY, Seoul (KR)

(72) Inventors: Sang-Young LEE, Seoul (KR); Soohyoung LEE, Seoul (KR); Kyeong-Seok OH, Seoul (KR)

(73) Assignee: UIF (UNIVERSITY INDUSTRY FOUNDATION), YONSEI UNIVERSITY, Seoul (KR)

(21) Appl. No.: 19/253,038

(22) Filed: Jun. 27, 2025

(30) Foreign Application Priority Data
Jun. 28, 2024 (KR) 10-2024-0085071
Jun. 25, 2025 (KR) 10-2025-0084205

(51) Int. Cl. H01M 10/0565; H01M 10/052

(52) U.S. Cl. CPC H01M 10/0565; H01M 10/052; H01M 2220/20; H01M 2220/30; H01M 2300/0082

(57) ABSTRACT

The present invention relates to a cationic polymer electrolyte and a method for preparing the same, wherein the polymer electrolyte of the present invention exhibits excellent ion transport properties.

### CROSS-REFERENCE TO RELATED APPLICATION

This application claims priority to Korean Patent Application No. 10-2024-0085071 filed on Jun. 28, 2024 and Korean Patent Application No. 10-2025-0084205 filed on Jun. 25, 2025 and all the benefits accruing therefrom under 35 U.S.C. § 119, the contents of which are incorporated by reference in their entirety.

### BACKGROUND

Lithium metal is attracting attention as a next-generation battery anode material due to its high theoretical capacity (3861 mAh g⁻¹) and low redox potential (−3.04 V vs. Standard hydrogen electrode). However, conventional liquid electrolytes are not well compatible with lithium metal anodes due to safety issues caused by high volatility and flammability, and liquid electrolytes are prone to depletion by continuously reacting with lithium metal anodes. Due to these problems, the transition to solid electrolytes for the use of lithium metal anodes is receiving significant attention. However, inorganic solid electrolytes represented by Argyrodite-type Li₆PS₅Cl still have many unresolved problems such as low processability, poor interfacial contact, and reactivity with lithium metal.

As an alternative to this, polymer-based solid electrolytes, which have mild processing conditions and excellent compatibility with lithium metal, are being regarded as the most promising candidates as electrolytes for lithium metal batteries. However, most research on polymer electrolytes has focused on improving the low ionic conductivity compared to liquid electrolytes and inorganic solid electrolytes, and studies dealing with interfacial properties that contribute more directly to the actual performance of lithium metal batteries are still insufficient. Research on the interfacial properties of polymer electrolytes with lithium metal has mainly focused on forming a robust solid electrolyte interphase (SEI) layer that is inorganic-rich (especially LiF-rich) and improving surface morphology by adopting early-stage liquid electrolyte research methods in the field, such as using an excessive amount of salt or introducing additives containing fluorine (F) groups.

Therefore, existing studies are limited to observing and partially improving the static state of lithium metal, and lack understanding and utilization of dynamic phenomena occurring at the actual interface.

### SUMMARY

The present invention has been devised to solve the above-mentioned problems, and an object of the present invention is to provide a composition for preparing a polymer electrolyte, comprising a cationic monomer; a multifunctional monomer; a plastic crystal; and a lithium salt.

In addition, another object of the present invention is to provide a polymer electrolyte prepared using the above composition for preparing a polymer electrolyte.

In addition, another object of the present invention is to provide a lithium metal battery comprising the above polymer electrolyte.

Furthermore, another object of the present invention is to provide a device comprising the above lithium metal battery, wherein the device is selected from the group consisting of a communication device, a transportation device, and an energy storage device.

In addition, another object of the present invention is to provide a method for preparing a polymer electrolyte, comprising:

(A) obtaining a composition for preparing a polymer electrolyte by mixing a cationic monomer, a multifunctional monomer, a plastic crystal, and a lithium salt; and (B) preparing the polymer electrolyte by polymerizing the composition for preparing a polymer electrolyte.

The objects of the present invention are not limited to the purposes mentioned above, and other objects and advantages of the present invention that are not mentioned can be understood through the following description and will be more clearly understood through the embodiments of the present invention. In addition, it will be easily understood that the objects and advantages of the present invention can be achieved by the means and combinations thereof described in the specification.

One aspect of the present invention provides a composition for preparing a polymer electrolyte, comprising a cationic monomer; a multifunctional monomer; a plastic crystal; and a lithium salt.

The cationic monomer may comprise at least one selected from the group consisting of imidazolium, pyridinium, phosphonium, sulfonium, pyrrolidinium, guanidinium, ammonium, isouronium, thiouronium, piperidinium, pyrazolium, methylium, and morpholinium.

The cationic monomer may comprise a cationic functional group; and an anionic functional group.

The anionic functional group may be an imide compound functional group.

The multifunctional monomer may comprise at least one selected from the group consisting of trimethylolpropane propoxylate triacrylate (TPPTA), ethoxylated trimethylolpropane triacrylate (ETPTA), trimethylolpropane triacrylate (TMPTA), and poly(ethylene glycol) diacrylate (PEGDA).

The molar ratio of the cationic monomer to the multifunctional monomer may be from 70 to 90:30 to 10.

The plastic crystal may be at least one selected from the group consisting of succinonitrile (butanedinitrile, C₂H₄(CN)₂), glutaronitrile, and adiponitrile. The content of the plastic crystal may be from 58 to 83 parts by weight based on 100 parts by weight of the total of the cationic monomer and the multifunctional monomer.

The lithium salt may comprise at least one selected from the group consisting of lithium bis(trifluoromethanesulfonyl)imide (LiTFSI), lithium bis(pentafluoroethanesulfonyl)imide (LiBETI), and lithium bis(fluorosulfonyl)imide (LiFSI).

The content of the lithium salt may be from 35 to 65 parts by weight based on 100 parts by weight of the total of the cationic monomer and the multifunctional monomer.

The composition for preparing the polymer electrolyte may further comprise at least one additive selected from the group consisting of vinylene carbonate and fluoroethylene carbonate (FEC).

The content of the additive may be from 1 to 10 parts by weight based on 100 parts by weight of the total of the cationic monomer and the multifunctional monomer.

The composition for preparing the polymer electrolyte may further comprise an initiator.

Another aspect of the present invention provides a polymer electrolyte prepared using the composition for preparing the polymer electrolyte.

Another aspect of the present invention provides a lithium metal battery comprising the polymer electrolyte.

Another aspect of the present invention provides a device comprising the lithium metal battery, wherein the device is selected from the group consisting of a communication device, a transportation device, and an energy storage device.

Another aspect of the present invention provides a method for preparing a polymer electrolyte, comprising:

(A) obtaining a composition for preparing a polymer electrolyte by mixing a cationic monomer, a multifunctional monomer, a plastic crystal, and a lithium salt; and (B) preparing the polymer electrolyte by polymerizing the composition for preparing the polymer electrolyte.

The polymerization may be performed at a temperature of 58 to 95° C. for 1 to 7 hours.

The means for solving the above problems do not enumerate all features of the present invention, and may be combined with certain embodiments described in the present specification. Various features of the present invention and the advantages and effects thereof can be understood in more detail with reference to the following detailed description.

The polymer electrolyte of the present invention exhibits excellent ion transport properties.

In addition to the above-described effects, specific effects of the present invention will be described together while explaining specific details for carrying out the invention below. Furthermore, the effects of the present invention are not limited to the effects mentioned above, and can be easily realized by the means and combinations thereof described in the specification

### BRIEF DESCRIPTION OF THE DRAWINGS

FIG. 1 is a schematic view illustrating the structure and dynamic response of a polymer electrolyte (WCCE, Control 2) according to one embodiment of the present invention and a polymer electrolyte (Control 1) in which a neutral polymer (matrix) is introduced.

FIG. 2 shows (a) a schematic diagram illustrating the molecular interactions in a polymer electrolyte (Control 1) in which a neutral polymer (matrix) is introduced and a polymer electrolyte (WCCE, Control 2) according to one embodiment of the present invention, and (b) FT-IR spectra, (c) ¹⁵N NMR spectra, and (d) ⁷Li NMR spectra of the polymer electrolytes prepared in Example 1 (WCCE), Example 2 (Control 2), and Comparative Example 1 (Control 1) of the present invention.

FIG. 3 shows (a) the Tafel slope, (b) voltage profiles (current density=0.1 mA cm⁻²/capacity=0.1 mA cm⁻²), and (c) voltage profiles (increased from 0.1 mA cm⁻² to 1.5 mA cm⁻² at a rate of 0.1 mA cm⁻² h⁻¹) of lithium metal batteries (Li∥Li cells) prepared in Example 1 (WCCE), Example 2 (Control 2), and Comparative Example 1 (Control 1) of the present invention, and (d)-(f) scanning electron microscope (SEM) images of the lithium metal anodes in the lithium metal batteries prepared in (d) Comparative Example 1 (Control 1), (e) Example 2 (Control 2), and (f) Example 1 (WCCE).

FIG. 4 shows the Nyquist plot of SUS∥SUS cells prepared in Example 1 (WCCE), Example 2 (Control 2), and Comparative Example 1 (Control 1) of the present invention.

FIG. 5 shows the current-time graphs (left) and Nyquist plots (right) under 10 mV polarization of lithium metal batteries (Li∥Li symmetric cells) prepared in (a, b) Comparative Example 1 (Control 1), (c, d) Example 2 (Control 2), and (e, f) Example 1 (WCCE) of the present invention.

FIG. 6 shows the Nyquist plots of lithium metal batteries prepared in Example 1 (WCCE), Example 2 (Control 2), and Comparative Example 1 (Control 1) of the present invention.

### DETAILED DESCRIPTION OF EMBODIMENTS

In the present specification, a singular expression includes a plural expression unless the context clearly indicates otherwise.

In the present specification, a numerical range indicated by the term “to” represents a numerical range including the values stated before and after the term as the lower and upper limits, respectively. For example, when “a to b” is described in the specification, it can be understood as meaning a range from a to b, inclusive.

In the present specification, when a plurality of numerical values are disclosed as the lower and upper limits of a numerical range, the numerical range disclosed in the specification can be understood as any numerical range having any one of the plurality of lower limit values and any one of the plurality of upper limit values as the lower limit and upper limit, respectively. For example, when “not less than a” or “not less than b”; and “not more than c” or “not more than d” are described, it can be understood as meaning “not less than a and not more than c,” “not less than a and not more than d,” “not less than b and not more than c,” or “not less than b and not more than d.”

One aspect of the present invention provides a composition for preparing a polymer electrolyte, comprising a cationic monomer; a multifunctional monomer; a plastic crystal; and a lithium salt.

When applied as a polymer electrolyte, the composition for preparing a polymer electrolyte according to the present invention exhibits dominant weak attractive interactions between the metal ion (Li⁺) and the solvent (or anion) due to the double coordination structure consisting of metal ion-solvent (or anion)-cationic polymer (polymerized from cationic monomer). Accordingly, since the metal ion has a primary coordination structure formed with the mobile phase solvent or anion, without directly interacting with the stationary phase cationic polymer matrix, the ion transport property in the bulk electrolyte is improved. In addition, due to the double coordination structure, the binding energy between the metal ion and the solvent (or anion) is reduced, thereby facilitating de-coordination of the metal ion at the electrolyte/electrode interface during battery charging, which reduces interfacial charge transfer resistance and suppresses lithium dendrite growth.

The present invention is characterized in that a polymer polymerized from a cationic monomer is used as the matrix of the polymer electrolyte, which, unlike neutral monomers and neutral polymers, is capable of directly interacting with the plastic crystal. This interaction reduces the lithium ion coordination ability of the plastic crystal that coordinates lithium ions in the electrolyte, thereby improving the lithium ion de-coordination kinetics at the interface (regulation of static lithium ion coordination structure), increasing ionic conductivity, and reducing charge transfer resistance at the electrode surface.

The cationic monomer may comprise at least one selected from the group consisting of imidazolium, pyridinium, phosphonium, sulfonium, pyrrolidinium, guanidinium, ammonium, isouronium, thiouronium, piperidinium, pyrazolium, methylium, and morpholinium; preferably, may comprise imidazolium; more preferably, may comprise imidazolium in which a methyl group is introduced at the 3-position of the imidazolium ring; and most preferably, may comprise 1-allyl-3-methylimidazolium.

The cationic monomer may be a salt compound comprising a cationic functional group; and an anionic functional group. The salt compound may refer to an ionic compound in which the cation and the anion are electrostatically bound to each other to exhibit a neutral state.

According to one embodiment of the present invention, in the case of the cationic monomer, the presence of a counter anion is essential, and therefore, the cationic functional group may be present together with a counter anion.

The features described in the above-described embodiment may be combined with other embodiments unless explicitly described otherwise. Although the preferred embodiments of the present invention have been described in detail above, the scope of the present invention is not limited thereto, and various modifications and improvements made by those skilled in the art using the basic concept of the present invention defined in the following claims also fall within the scope of the present invention.

The cationic functional group may be at least one functional group selected from the group consisting of imidazolium, pyridinium, phosphonium, sulfonium, pyrrolidinium, guanidinium, ammonium, isouronium, thiouronium, piperidinium, pyrazolium, methylium, and morpholinium; preferably, the cationic functional group may be an imidazolium functional group; more preferably, the functional group may be a functional group in which a methyl group is introduced at the 3-position of the imidazolium ring; and most preferably, the functional group may be a 1-allyl-3-methylimidazolium functional group.

In particular, it is most preferable when the cationic monomer comprises a compound of 1-allyl-3-methylimidazolium or a functional group thereof, as the chemical stability can be significantly increased.

The anionic functional group may be an imide compound functional group, and more preferably, may be a bis(trifluoromethanesulfonyl)imide functional group. In particular, bis(trifluoromethanesulfonyl)imide is more preferably used as an anionic functional group, since it facilitates salt dissociation and forms F-containing decomposition products at the electrode, which can increase reversibility.

According to a preferred embodiment of the present invention, the cationic monomer may be 1-allyl-3-methylimidazolium bis(trifluoromethylsulfonyl)imide (AMIM-TFSI). In particular, AMIM-TFSI is most preferable, since unlike other cationic monomers, it can reduce charge transfer resistance by at least 10%.

The multifunctional monomer may be a compound having a polymerizable functional group capable of bonding with the cationic monomer, and preferably, may be a multifunctional monomer having two or more of the polymerizable functional groups.

The polymerizable functional group may be an acryl group.

The polymerizable functional group may react and bond with the cationic functional group of the cationic monomer to interconnect the cationic monomers and form a polymer.

The multifunctional monomer may comprise at least one selected from the group consisting of trimethylolpropane propoxylate triacrylate (TPPTA), ethoxylated trimethylolpropane triacrylate (ETPTA), trimethylolpropane triacrylate (TMPTA), and poly(ethylene glycol) diacrylate (PEGDA); preferably, may be a polyol ester-based acrylate compound; and more preferably, may be trimethylolpropane propoxylate triacrylate (TPPTA).

The cationic monomer and the multifunctional monomer are each present in the composition, but they are polymerized to form a polymer.

The molar ratio of the cationic monomer to the multifunctional monomer may be from 70 to 90:30 to 10, preferably from 73 to 87:27 to 13, more preferably from 75 to 85:25 to 15, and most preferably from 68 to 82:32 to 18.

When the cationic monomer and the multifunctional monomer are used outside the above molar ratio, the mechanical properties of the resulting polymer electrolyte may deteriorate, and a large number of defects may occur on the surface.

The plastic crystal increases the dielectric constant of the polymer electrolyte and weakens the bonding between the cationic polymer matrix, which is derived from the cationic monomer, and the metal ion.

The plastic crystal may be at least one selected from the group consisting of succinonitrile (butanedinitrile, C₂H₄(CN)₂), glutaronitrile, and adiponitrile.

The nitrile-based compound may be a nitrile-based compound having 2 to 5 carbon atoms, excluding the nitrile group within the molecule. Nitrile-based compounds having more than 5 carbon atoms are not suitable for use in electrolytes due to their solid phase or high viscosity.

The content of the plastic crystal may be from 58 to 83 parts by weight, preferably from 60 to 80 parts by weight, more preferably from 62 to 77 parts by weight, and most preferably from 65 to 75 parts by weight, based on 100 parts by weight of the total of the cationic monomer and the multifunctional monomer (thermosetting composition).

When the plastic crystal is used in an amount smaller than the above range based on 100 parts by weight of the thermosetting composition, the ionic conductivity may significantly decrease, and lithium dendrites may be generated even without prolonged cycling. On the other hand, when used in an excessive amount, the crosslinking density of the polymer electrolyte may decrease, and it may fail to exhibit solid-state properties.

In addition, the composition for preparing the polymer electrolyte of the present invention is characterized in that a lithium salt is used together with the plastic crystal, and the plastic crystal, in the presence of the lithium salt, becomes liquid, thereby making the polymer electrolyte prepared using the same into a gel electrolyte.

The lithium salt may comprise at least one selected from the group consisting of lithium bis(trifluoromethanesulfonyl)imide (LiTFSI), lithium bis(pentafluoroethanesulfonyl)imide (LiBETI), and lithium bis(fluorosulfonyl)imide (LiFSI); preferably, the lithium salt may be lithium bis(fluorosulfonyl)imide (LiFSI, LiF₂NO₄S₂).

The content of the lithium salt may be from 35 to 65 parts by weight, preferably from 37 to 63 parts by weight, more preferably from 40 to 60 parts by weight, and most preferably from 45 to 55 parts by weight, based on 100 parts by weight of the total of the cationic monomer and the multifunctional monomer (thermosetting composition).

When the lithium salt is used in an amount smaller than the above range based on 100 parts by weight of the total of the cationic monomer and the multifunctional monomer (thermosetting composition), dynamic lithium ion coordination structure regulation may not be achieved, and the effect of reducing interfacial charge transfer resistance may fall short of expectations. On the other hand, when used in an excessive amount, the lithium ion conductivity of the polymer electrolyte may be significantly decreased.

In particular, the composition for preparing a polymer electrolyte of the present invention can increase the content of the lithium salt up to the solubility limit to increase the proportion of anions included in the primary coordination structure within the polymer electrolyte. As a result, the Li⁺ coordination energy is reduced, and during charging, the lithium metal anode becomes negatively polarized, causing repulsion of anions from the surface. This further reduces the Li⁺ coordination energy at the electrolyte/anode interface, thereby facilitating Li⁺ de-coordination during charging and further reducing interfacial charge transfer resistance, which suppresses lithium dendrite growth. In addition, it promotes the decomposition of anions at the lithium metal anode, forming a LiF-rich SEI to stabilize the interface and further suppress lithium dendrite growth.

According to a preferred embodiment of the present invention, the cationic monomer is 1-allyl-3-methylimidazolium bis(trifluoromethanesulfonyl)imide (AMIM-TFSI), the multifunctional monomer is trimethylolpropane propoxylate triacrylate (TPPTA), and the plastic crystal may be at least one selected from the group consisting of succinonitrile (butanedinitrile, C₂H₄ (CN)₂), glutaronitrile, and adiponitrile.

When the composition for preparing a polymer electrolyte of the present invention satisfies all the components according to the preferred embodiment, it was confirmed that it is more preferable in that, even after 250 charge-discharge cycles using a lithium metal battery prepared with the polymer electrolyte produced therefrom, no defects occurred on the surface of the polymer electrolyte. However, when any one of the components of the preferred embodiment was not satisfied, defects were generated on the surface of the polymer electrolyte after 250 charge-discharge cycles.

According to another preferred embodiment of the present invention, the molar ratio of the cationic monomer to the multifunctional monomer is 68 to 82:32 to 18, the content of the plastic crystal is from 65 to 75 parts by weight based on 100 parts by weight of the total of the cationic monomer and the multifunctional monomer, and the lithium salt may be from 45 to 55 parts by weight.

When the composition of the composition for preparing a polymer electrolyte of the present invention satisfies all the numerical ranges of the above-described another preferred embodiment, it was confirmed that the mechanical properties and surface uniformity of the polymer electrolyte, prepared using the composition and applied to a lithium metal battery, were maintained the same as the initial state even after 250 charge-discharge cycles. However, when any one of the compositional ranges of the another preferred embodiment was not satisfied, the surface uniformity was degraded compared to the initial state after 250 charge-discharge cycles, and the mechanical properties decreased by at least 7%.

The composition for preparing the polymer electrolyte may further comprise an additive.

The additive serves to stabilize the surface of the lithium metal, and specifically, may be at least one selected from the group consisting of vinylene carbonate and fluoroethylene carbonate (FEC); preferably, the additive may be fluoroethylene carbonate (FEC).

The content of the additive may be from 1 to 10 parts by weight, preferably from 2 to 7 parts by weight, based on 100 parts by weight of the thermosetting composition.

When the additive is used in an amount smaller than the above range based on 100 parts by weight of the thermosetting composition, stabilization of the lithium metal anode may be difficult. On the other hand, when used in an excessive amount, the additive may decompose itself excessively, thereby lowering the Coulombic efficiency.

The composition for preparing the polymer electrolyte may further comprise an initiator.

The initiator induces a polymerization reaction of the cationic monomer and the multifunctional monomer to form a polymer.

The initiator is not particularly limited as long as it is a substance that induces the polymerization reaction of the cationic monomer and the multifunctional monomer, and in one embodiment, it may be 2,2′-azobis(2-methylpropionitrile) (AIBN).

The content of the initiator may be from 0.05 to 10 parts by weight, preferably from 0.1 to 7 parts by weight, based on 100 parts by weight of the thermosetting composition.

When the initiator is used in an amount smaller than the above range based on 100 parts by weight of the thermosetting composition, the polymer may not be sufficiently formed. On the other hand, when used in an excessive amount, it may cause side reactions in the battery and deteriorate battery performance.

Another aspect of the present invention provides a polymer electrolyte prepared using the composition for preparing the polymer electrolyte.

The polymer electrolyte may be prepared by polymerizing the composition for preparing the polymer electrolyte, and the polymerization may be thermal polymerization or photopolymerization.

The polymer electrolyte may comprise a cationic polymer matrix polymerized from a thermosetting composition comprising the cationic monomer and the multifunctional monomer.

The room temperature ionic conductivity of the polymer electrolyte may be from 1.2×10⁻³ to 2.1×10⁻³ S/cm, and the room temperature charge transfer resistance may be from 30 to 50Ω.

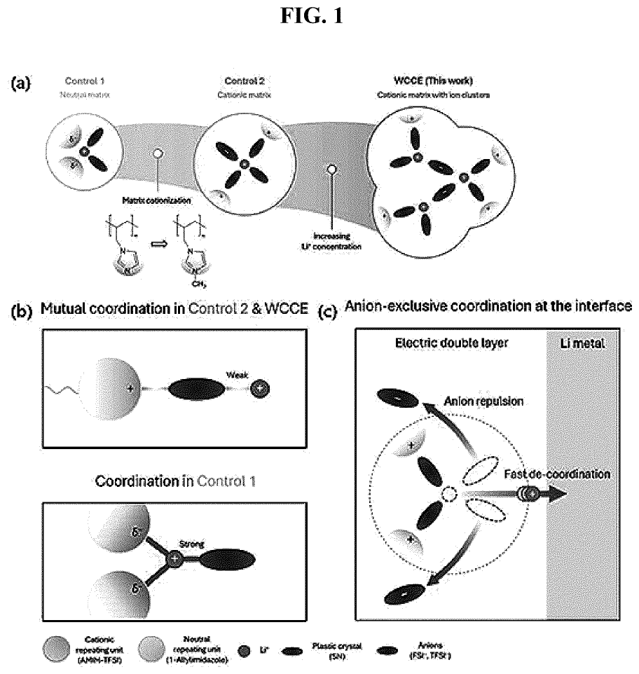

FIG. 1 is a schematic diagram illustrating the structure and dynamic response of a polymer electrolyte (WCCE, Control 2) according to one embodiment of the present invention and a polymer electrolyte (Control 1) in which a neutral polymer (matrix) is introduced.

As shown in FIG. 1, the polymer electrolyte (Control 1) in which a neutral polymer (matrix) is introduced exhibits strong interaction between the metal (lithium) and the neutral polymer, making ion transport difficult and limiting metal plating/stripping. Even when a plastic crystal is further added, the plastic crystal also strongly interacts with the metal, thereby further restricting the metal plating/stripping.

In addition, the polymer electrolyte (WCCE, Control 2) according to one embodiment of the present invention allows regulation of a static coordination structure due to the double coordination structure of metal ion (Li⁺)-solvent (or anion)-cationic polymer. As a result, Li⁺ does not directly interact with the stationary phase cationic polymer matrix but instead forms a primary coordination structure with the mobile phase solvent or anion, thereby improving ion transport properties in the bulk electrolyte. Furthermore, the binding energy between Li⁺ and the solvent (or anion) is reduced, facilitating Li⁺ de-coordination at the electrolyte/anode interface during charging.

In addition, the WCCE has a higher concentration of lithium salt than the polymer electrolyte (Control 2) in which the cationic polymer is introduced. By increasing the concentration of the lithium salt, the proportion of anions in the primary coordination structure is further increased, thereby achieving additional reduction in binding energy through utilization of anion repulsion at the lithium metal anode interface during charging, and accomplishing regulation of both static and dynamic coordination structures.

In addition, the present invention provides a lithium metal battery comprising the polymer electrolyte.

Furthermore, the present invention provides a device comprising the lithium metal battery, wherein the device is selected from the group consisting of a communication device, a transportation device, and an energy storage device.

Another aspect of the present invention provides a method for preparing a polymer electrolyte, comprising:

(A) obtaining a composition for preparing a polymer electrolyte by mixing a cationic monomer, a multifunctional monomer, a plastic crystal, and a lithium salt; and (B) preparing the polymer electrolyte by polymerizing the composition for preparing the polymer electrolyte.

### (A) Obtaining a Composition for Preparing a Polymer Electrolyte by Mixing a Cationic Monomer, a Multifunctional Monomer, a Plastic Crystal, and a Lithium Salt

The step (A) is a step of obtaining a composition for preparing a polymer electrolyte by mixing a cationic monomer, a multifunctional monomer, a plastic crystal, and a lithium salt.

The cationic monomer may comprise at least one selected from the group consisting of imidazolium, pyridinium, phosphonium, sulfonium, pyrrolidinium, guanidinium, ammonium, isouronium, thiouronium, piperidinium, pyrazolium, methylium, and morpholinium; preferably, may comprise imidazolium; more preferably, may comprise imidazolium in which a methyl group is introduced at the 3-position of the imidazolium ring; and most preferably, may comprise 1-allyl-3-methylimidazolium.

The cationic monomer may be a salt compound comprising a cationic functional group; and an anionic functional group.

The cationic functional group may be at least one functional group selected from the group consisting of imidazolium, pyridinium, phosphonium, sulfonium, pyrrolidinium, guanidinium, ammonium, isouronium, thiouronium, piperidinium, pyrazolium, methylium, and morpholinium; preferably, may be an imidazolium functional group; more preferably, may be a functional group in which a methyl group is introduced at the 3-position of the imidazolium ring; and most preferably, may be a 1-allyl-3-methylimidazolium functional group.

The anionic functional group may be an imide compound functional group, and more preferably, may be a bis(trifluoromethanesulfonyl)imide functional group.

According to a preferred embodiment of the present invention, the cationic monomer may be 1-allyl-3-methylimidazolium bis(trifluoromethanesulfonyl)imide (AMIM-TFSI).

The multifunctional monomer may be a compound having a polymerizable functional group capable of bonding with the cationic monomer, and preferably, may be a multifunctional monomer having two or more of the polymerizable functional groups.

The polymerizable functional group may be an acryl group.

The polymerizable functional group may react and bond with the cationic functional group of the cationic monomer to interconnect the cationic monomers and form a polymer.

The multifunctional monomer may be an acrylate compound, preferably a polyol ester-based acrylate compound, and more preferably, trimethylolpropane propoxylate triacrylate (TPPTA).

The cationic monomer and the multifunctional monomer are each present in the composition, but they are polymerized to form a polymer.

The molar ratio of the cationic monomer to the multifunctional monomer may be from 70 to 90:30 to 10, preferably from 73 to 87:27 to 13, more preferably from 75 to 85:25 to 15, and most preferably from 68 to 82:32 to 18.

The plastic crystal may be at least one selected from the group consisting of succinonitrile (butanedinitrile, C₂H₄ (CN)₂), glutaronitrile, and adiponitrile.

The content of the plastic crystal may be from 58 to 83 parts by weight, preferably from 60 to 80 parts by weight, more preferably from 62 to 77 parts by weight, and most preferably from 65 to 75 parts by weight, based on 100 parts by weight of the total of the cationic monomer and the multifunctional monomer (thermosetting composition).

The lithium salt may comprise at least one selected from the group consisting of lithium bis(trifluoromethanesulfonyl)imide (LiTFSI), lithium bis(pentafluoroethanesulfonyl)imide (LiBETI), and lithium bis(fluorosulfonyl)imide (LiFSI); preferably, the lithium salt may be lithium bis(fluorosulfonyl)imide (LiFSI, LiF₂NO₄S₂).

The content of the lithium salt may be from 35 to 65 parts by weight, preferably from 37 to 63 parts by weight, more preferably from 40 to 60 parts by weight, and most preferably from 45 to 55 parts by weight, based on 100 parts by weight of the total of the cationic monomer and the multifunctional monomer (thermosetting composition).

The composition for preparing the polymer electrolyte may further comprise an additive.

The additive may be at least one selected from the group consisting of vinylene carbonate and fluoroethylene carbonate (FEC); preferably, the additive may be fluoroethylene carbonate (FEC).

The content of the additive may be from 1 to 10 parts by weight, preferably from 2 to 7 parts by weight, based on 100 parts by weight of the thermosetting composition.

The composition for preparing the polymer electrolyte may further comprise an initiator.

The initiator may be 2,2′-azobis(2-methylpropionitrile) (AIBN). The content of the initiator may be from 0.05 to 10 parts by weight, preferably from 0.1 to 7 parts by weight, based on 100 parts by weight of the thermosetting composition.

### (B) Preparing the Polymer Electrolyte by Polymerizing the Composition for Preparing the Polymer Electrolyte

The step (B) is a step of preparing a polymer electrolyte by polymerizing the composition for preparing the polymer electrolyte.

In the step (B), a polymer may be polymerized from a thermosetting composition comprising the cationic monomer and the multifunctional monomer.

The polymerization may be thermal polymerization or photopolymerization.

The thermal polymerization may be performed at a temperature of 58 to 95° C. for 1 to 7 hours, preferably at 60 to 90° C. for 2 to 6 hours, more preferably at 63 to 85° C. for 2.3 to 5 hours, and most preferably at 65 to 78° C. for 2.5 to 4 hours.

When either the temperature or time of the thermal polymerization is below the lower limit, the mechanical properties of the polymer electrolyte may deteriorate, and conversely, when either exceeds the upper limit, a large amount of by-products may be generated. When either the temperature or time of the thermal polymerization is below the lower limit, the mechanical properties of the polymer electrolyte may deteriorate, and conversely, when either exceeds the upper limit, a large amount of by-products may be generated.

Although not explicitly described in the following examples and comparative examples, after preparing a polymer electrolyte by varying the following conditions in the method for preparing the polymer electrolyte of the present invention, a lithium metal battery was prepared using the polymer electrolyte, and subjected to 800 charge-discharge cycles by conventional methods.

As a result, when all the following conditions were satisfied, lithium dendrites were not formed at all even after 250 charge-discharge cycles, and the ionic conductivity and interfacial charge transfer resistance characteristics were maintained at the same level as initially, confirming that long-term stability was particularly excellent.

However, when any one of the following conditions is not satisfied, lithium dendrites were observed starting from up to 250 charge-discharge cycles, or the ionic conductivity and interfacial charge transfer resistance characteristics decreased by 8% or more compared to the initial state, resulting in somewhat reduced long-term stability.
(1) The cationic monomer is 1-allyl-3-methylimidazolium bis(trifluoromethanesulfonyl)imide (AMIM-TFSI);
(2) The multifunctional monomer is trimethylolpropane propoxylate triacrylate (TPPTA);
(3) The molar ratio of the cationic monomer to the multifunctional monomer is from 68 to 82:32 to 18;
(4) The plastic crystal is at least one selected from the group consisting of succinonitrile (butanedinitrile, C₂H₄ (CN)₂), glutaronitrile, and adiponitrile;
(5) The content of the plastic crystal is from 65 to 75 parts by weight based on 100 parts by weight of the total of the cationic monomer and the multifunctional monomer;
(6) The content of the lithium salt is from 45 to 55 parts by weight based on 100 parts by weight of the total of the cationic monomer and the multifunctional monomer;
(7) The composition for preparing the polymer electrolyte further comprises fluoroethylene carbonate (FEC);
(8) The content of fluoroethylene carbonate (FEC) is from 2 to 7 parts by weight based on 100 parts by weight of the total of the cationic monomer and the multifunctional monomer; and
(9) The polymerization may be performed at 65 to 78° C. for 2.5 to 4 hours.

The present invention will be described in more detail below through examples and the like; however, the scope and content of the present invention should not be interpreted as being limited or restricted by the examples and the like described below.

### Example 1. Weakly Coordinating Cationic Polymer Electrolyte (WCCE) and a Lithium Metal Battery Comprising the Same

A precursor solution was prepared by mixing a cationic monomer (1-allyl-3-methylimidazolium bis(trifluoromethylsulfonyl)imide (AMIM-TFSI)), a crosslinker (trimethylolpropane propoxylate triacrylate (TPPTA)), a plastic crystal (succinonitrile, SN), a lithium salt (lithium bis(fluorosulfonyl)imide (LiFSI)), an additive (fluoroethylene carbonate (FEC)), and an initiator (2,2′-azobis(2-methylpropionitrile) (AIBN)) at a weight ratio of 100:40:100:72:6:0.5.

At this time, the molar ratio of the cationic monomer to the crosslinker was 80:20.

Then, after injecting the precursor solution into the cell and assembling it, the lithium metal battery including the polymer electrolyte formed by an in situ method was prepared by heating at 70° C. for 3 hours.

### Example 2. Control 2

A precursor solution was prepared by mixing a cationic monomer (1-allyl-3-methylimidazolium bis(trifluoromethylsulfonyl)imide (AMIM-TFSI)), a crosslinker (trimethylolpropane propoxylate triacrylate (TPPTA)), a plastic crystal (succinonitrile, SN), a lithium salt (lithium bis(fluorosulfonyl)imide (LiFSI)), an additive (fluoroethylene carbonate (FEC)), and an initiator (2,2′-azobis(2-methylpropionitrile) (AIBN)) at a weight ratio of 100:40:100:29:5.5:0.5. At this time, the molar ratio of the cationic monomer to the crosslinker was 80:20.

Then, after injecting the precursor solution into the cell and assembling it, the lithium metal battery including the polymer electrolyte formed by an in situ method was prepared by heating at 70° C. for 3 hours.

### Comparative Example 1. Control 1

A precursor solution was prepared by mixing a neutral monomer (trimethylolpropane 1-allylimidazole), a crosslinker (trimethylolpropane propoxylate triacrylate (TPPTA)), a plastic crystal (succinonitrile, SN), a lithium salt (lithium bis(fluorosulfonyl)imide (LiFSI)), an additive (fluoroethylene carbonate (FEC)), and an initiator (2,2′-azobis(2-methylpropionitrile) (AIBN)) at a weight ratio of 100:149:370:108:15:2. At this time, the molar ratio of the neutral monomer to the crosslinker was 80:20.

Then, after injecting the precursor solution into the cell and assembling it, the lithium metal battery including the polymer electrolyte formed by an in situ method was prepared by heating at 70° C. for 3 hours.

\

### Experimental Example 1. Coordination Energy Analysis

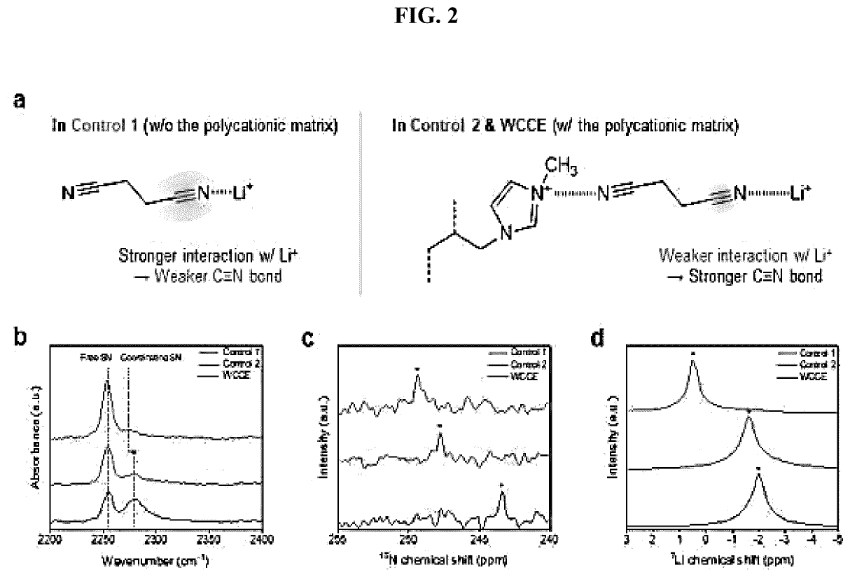

FIG. 2 shows (a) a schematic diagram illustrating the interactions of molecules within a polymer electrolyte (Control 1) in which a neutral polymer (matrix) is introduced and a polymer electrolyte (WCCE, Control 2) according to one embodiment of the present invention, and (b) FT-IR spectra, (c) ¹⁵N NMR spectra, and (d) ⁷Li NMR spectra of polymer electrolytes prepared in Example 1 (WCCE), Example 2 (Control 2), and Comparative Example 1 (Control 1) of the present invention.

As shown in (b) of FIG. 2, in Example 1 (WCCE) and Example 2 (Control 2), which include the cationic monomer, the nitrile (in SN)—Li⁺ interaction is weakened, reducing the degree to which nitrile (in SN) donates electron density to Li⁺. As a result, the C≡N bond strength (in SN) increased, and the FT-IR peak corresponding to coordinating SN due to mutual coordination was detected at a higher wavenumber (2280 cm⁻¹ vs. 2276 cm⁻¹) compared to Comparative Example 1 (Control 1).

As shown in (c) of FIG. 2, the lithium ion coordination is statically regulated, resulting in a decrease in the degree to which nitrile donates electron density to Lit. This causes localization of electrons in the nitrile group, and it was confirmed that the peak of the nitrile group was shielded in the ¹⁵N NMR spectrum.

As shown in (d) of FIG. 2, in Example 1 (WCCE) and Example 2 (Control 2), which include the cationic monomer, the presence of mutual coordination decreases the coordinating ability of the ligand, increasing the proportion of anions within the Li⁺ coordination sheath. As a result, lithium ion coordination is statically regulated, and an upshift of the Li⁺ peak was observed in the ⁷Li NMR spectrum.

In addition, compared to Example 2 (Control 2), Example 1 (WCCE) showed an upshift of the Lit peak due to the effect of mutual coordination and an increased ion pairing effect resulting from the introduction of a high concentration lithium salt. That is, as shown in FIG. 2, with the introduction of the cationic monomer, the interaction between lithium ions and the plastic crystal is weakened, resulting in an increase in the bond strength of the nitrile bond in the plastic crystal (succinonitrile).

### Experimental Example 2. Electrochemical Performance Evaluation

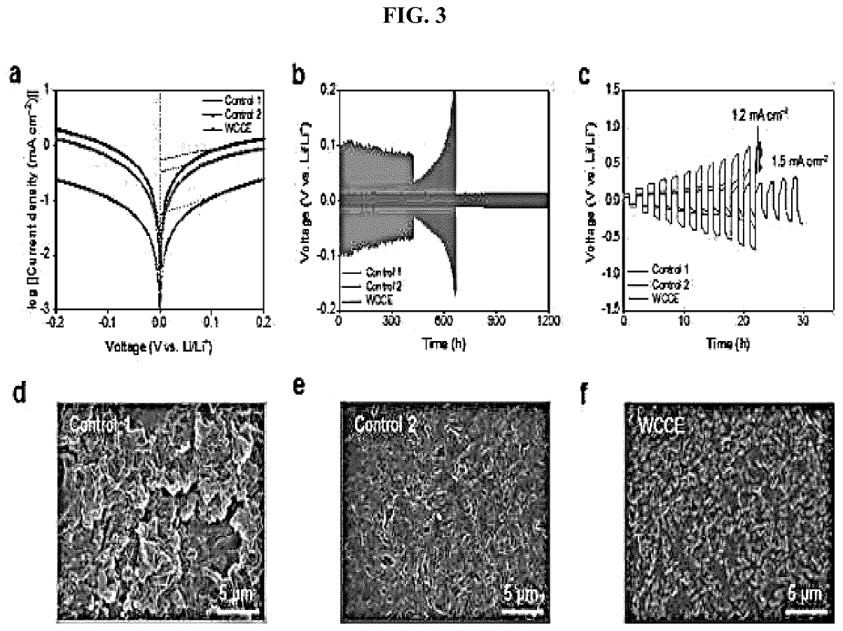

The electrochemical performance of lithium metal batteries prepared in Example 1 and Comparative Examples 1 to 2 was evaluated, and the results are shown in (a) to (c) of FIG. 3.

FIG. 3 shows (a) the Tafel slopes, (b) the voltage profiles (current density=0.1 mA/cm², capacity=0.1 mA/cm²), and (c) the voltage profiles (current density increased from 0.1 mA/cm² to 1.5 mA/cm² at a rate of 0.1 mA/cm²·h⁻¹) of lithium metal batteries (Li∥Li cells) prepared in Example 1 (WCCE), Example 2 (Control 2), and Comparative Example 1 (Control 1) of the present invention.

As shown in (a) of FIG. 3, in Examples 1 and 2, lithium ion de-coordination is promoted, improving the kinetics of the electrochemical reaction, resulting in higher exchange current density compared to the comparative example.

As shown in (b) of FIG. 3, compared to the comparative example, the examples exhibited lower overvoltage and superior lifetime characteristics due to improved electrochemical reaction kinetics. In particular, among the examples, Example 1 exhibited an overvoltage of 15 mV or less for more than 1000 hours at a current density of 0.1 mA/cm² and a capacity of 0.1 mA/cm².

As shown in (c) of FIG. 3, the examples exhibit a higher limiting current density based on improved electrochemical reaction kinetics compared to the comparative examples.

### Experimental Example 3. Surface Evaluation

In order to demonstrate the Li plating/stripping stability of lithium metal batteries prepared in Example 1 and Comparative Examples 1 to 2, the surface morphology of the lithium metal anode after 50 cycles at a current density of 0.1 mA/cm² and a capacity of 0.1 mAh/cm² was analyzed by scanning electron microscopy (SEM), and the results are shown in (d) to (f) of FIG. 3.

FIG. 3 shows scanning electron microscope (SEM) images of lithium metal anodes in lithium metal batteries prepared in (d) Comparative Example 1 (Control 1), (e) Example 2 (Control 2), and (f) Example 1 (WCCE) of the present invention.

As shown in (d) to (f) of FIG. 3, the lithium metal anode of Comparative Example 1 exhibited dendrite formation with a porous surface, whereas Example 2, in which the coordination structure was partially regulated, formed a denser morphology with reduced dendrite growth. Example 1, in which all strategies capable of regulating the coordination structure were applied, induced the formation of the densest and dendrite-free uniform lithium metal surface morphology. This is because the low de-coordination energy barrier induces uniform lithium metal deposition, which is advantageous for forming a dense lithium metal surface with suppressed dendrite growth.

### Experimental Example 4. Charge Transfer Characteristic Evaluation

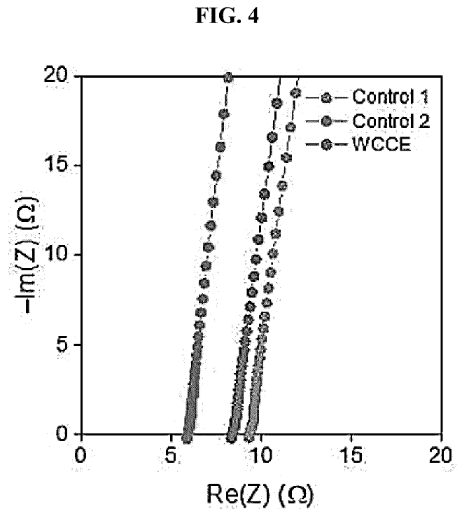

The room temperature ionic conductivity of SUS∥SUS cells prepared in Example 1 and Comparative Examples 1 to 2 was measured, and the results are shown in FIG. 4 and Table 1 below. FIG. 4 shows Nyquist plots of SUS∥SUS cells prepared in Example 1 (WCCE), Example 2 (Control 2), and Comparative Example 1 (Control 1) of the present invention.

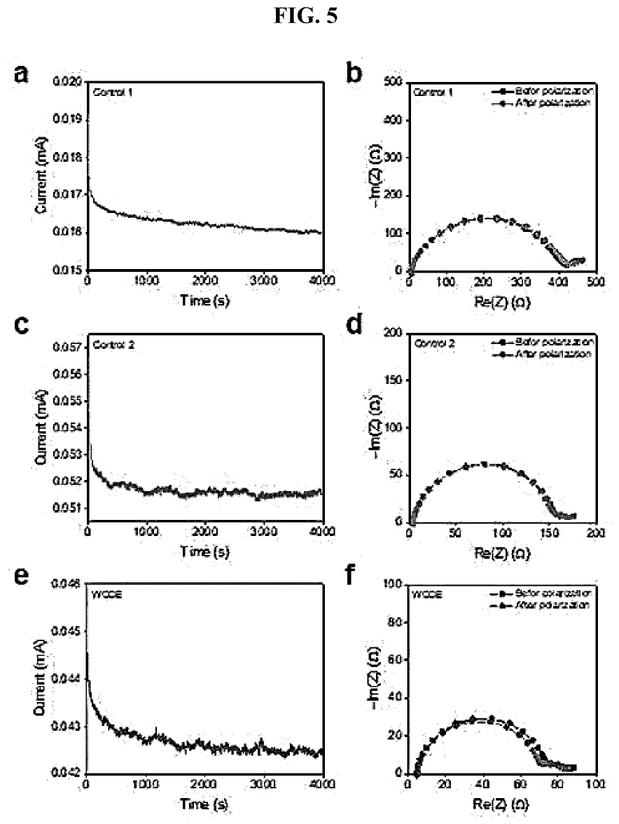

The room temperature cationic yield (and lithium ion conductivity) of lithium metal batteries prepared in Example 1 and Comparative Examples 1 to 2 was measured, and the results are shown in FIG. 5 and Tables 1 to 2 below.

FIG. 5 shows current-time graphs (left) and Nyquist plots (right) under 10 mV polarization of lithium metal batteries (Li∥Li symmetric cells) prepared in (a, b) Comparative Example 1 (Control 1), (c, d) Example 2 (Control 2), and (e, f) Example 1 (WCCE) of the present invention.

TABLE 1

| | Control 1 | Control 2 | WCCE |
|---|---|---|---|
| t_{Li}⁺ | 0.55 | 0.57 | 0.88 |
| σ (mS cm⁻¹) | 1.56 | 2.46 | 1.73 |
| σ_{Li}⁺ (mS cm⁻¹) | 0.86 | 1.40 | 1.52 |

TABLE 2

| | Applied voltage | I₀ | I₅ | R₀ | R₅ | |
|---|---|---|---|---|---|---|
| | (mV) | (μA) | (μA) | (Ω) | (Ω) | t_{Li+} |
| Control 1 | 10 | 19.16 | 16.00 | 406.2 | 415.3 | 0.55 |
| Control 2 | 10 | 56.69 | 51.54 | 151.20 | 150.00 | 0.57 |
| WCCE | 10 | 45.53 | 42.45 | 70.08 | 65.60 | 0.88 |

As shown in FIGS. 4 and 5 and Tables 1 to 2, lithium ion de-coordination was promoted in Example 1 (WCCE) and Example 2 (Control 2), resulting in improved lithium ion conductivity compared to Comparative Example 1 (Control 1).

### Room Temperature Charge Transfer Resistance

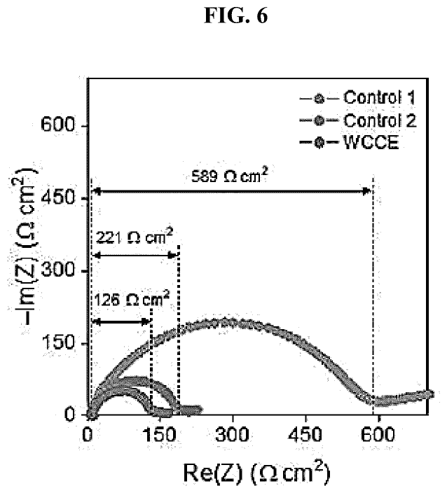

The room temperature charge transfer resistance of lithium metal batteries prepared in Example 1 and Comparative Examples 1 to 2 was measured, and the results are shown in FIG. 6 and Table 3 below.

FIG. 6 shows Nyquist plots of lithium metal batteries prepared in Example 1 (WCCE), Example 2 (Control 2), and Comparative Example 1 (Control 1) of the present invention.

TABLE 3

| | Control 1 | Control 2 | WCCE |
|---|---|---|---|
| R_{ct} (Ω cm²) | 589 | 221 | 126 |

As shown in FIG. 6 and Table 3, lithium ion de-coordination is promoted in lithium metal batteries prepared in the examples compared to the comparative example, resulting in reduced charge transfer resistance at the lithium metal anode surface. Among them, it can be seen that the charge transfer resistance reduction effect of Example 1 is superior.

Although the embodiments of the present invention have been described above, those skilled in the art will appreciate that various modifications and changes can be made to the present invention without departing from the spirit of the invention as defined in the claims, including addition, modification, deletion, or supplementation of components, and such modifications and changes are also encompassed within the scope of the present invention.

What is claimed is:

1. A composition for preparing a polymer electrolyte, comprising:
a cationic monomer;
a multifunctional monomer;
a plastic crystal; and
a lithium salt.

2. The composition for preparing a polymer electrolyte according to claim 1, wherein the cationic monomer comprises at least one selected from the group consisting of imidazolium, pyridinium, phosphonium, sulfonium, pyrrolidinium, guanidinium, ammonium, isouronium, thiouronium, piperidinium, pyrazolium, methylium, and morpholinium.

3. The composition for preparing a polymer electrolyte according to claim 1, wherein the cationic monomer comprises a cationic functional group; and an anionic functional group.

4. The composition for preparing a polymer electrolyte according to claim 3, wherein the anionic functional group is an imide compound functional group.

5. The composition for preparing a polymer electrolyte according to claim 1, wherein the multifunctional monomer comprises at least one selected from the group consisting of trimethylolpropane propoxylate triacrylate (TPPTA), ethoxylated trimethylolpropane triacrylate (ETPTA), trimethylolpropane triacrylate (TMPTA), and poly(ethylene glycol) diacrylate (PEGDA).

6. The composition for preparing a polymer electrolyte according to claim 1, wherein the molar ratio of the cationic monomer to the multifunctional monomer is from 70 to 90:30 to 10.

7. The composition for preparing a polymer electrolyte according to claim 1, wherein the plastic crystal is at least one selected from the group consisting of succinonitrile (butanedinitrile, C₂H₄(CN)₂), glutaronitrile, and adiponitrile.

8. The composition for preparing a polymer electrolyte according to claim 1, wherein the content of the plastic crystal is from 58 to 83 parts by weight based on 100 parts by weight of the total of the cationic monomer and the multifunctional monomer.

9. The composition for preparing a polymer electrolyte according to claim 1, wherein the lithium salt comprises at least one selected from the group consisting of lithium bis(trifluoromethanesulfonyl)imide (LiTFSI), bis(pentafluoroethanesulfonyl)imide (LiBETI), and lithium bis(fluorosulfonyl)imide (LiFSI).

10. The composition for preparing a polymer electrolyte according to claim 1, wherein the content of the lithium salt is from 35 to 65 parts by weight based on 100 parts by weight of the total of the cationic monomer and the multifunctional monomer.

11. The composition for preparing a polymer electrolyte according to claim 1, further comprising at least one additive selected from the group consisting of vinylene carbonate and fluoroethylene carbonate (FEC).

12. The composition for preparing a polymer electrolyte according to claim 11, wherein the content of the additive is from 1 to 10 parts by weight based on 100 parts by weight of the total of the cationic monomer and the multifunctional monomer.

13. The composition for preparing a polymer electrolyte according to claim 1, further comprising an initiator.

14. A polymer electrolyte prepared using the composition for preparing a polymer electrolyte according to claim 1.

15. A lithium metal battery comprising the polymer electrolyte according to claim 14.

16. An apparatus comprising the lithium metal battery according to claim 15, wherein the apparatus is any one selected from the group consisting of a communication device, a transportation device, and an energy storage device.

17. A method for preparing a polymer electrolyte, comprising:
(A) mixing a cationic monomer, a multifunctional monomer, a plastic crystal, and a lithium salt to obtain a composition for preparing a polymer electrolyte; and (B) polymerizing the composition for preparing the polymer electrolyte to prepare the polymer electrolyte.

18. The method for preparing a polymer electrolyte according to claim 17, wherein the polymerization is performed at 58 to 95° C. for 1 to 7 hours.

19. The method for preparing a polymer electrolyte according to claim 17, wherein:
the cationic monomer is 1-allyl-3-methylimidazolium bis(trifluoromethylsulfonyl)imide (AMIM-TFSI);
the multifunctional monomer is trimethylolpropane propoxylate triacrylate (TPPTA);
the molar ratio of the cationic monomer to the multifunctional monomer is from 68 to 82:32 to 18;
the plastic crystal is at least one selected from the group consisting of succinonitrile (butanedinitrile, C₂H₄(CN)₂), glutaronitrile, and adiponitrile;
the content of the plastic crystal is from 65 to 75 parts by weight based on 100 parts by weight of the total of the cationic monomer and the multifunctional monomer;
the content of the lithium salt is from 45 to 55 parts by weight based on 100 parts by weight of the total of the cationic monomer and the multifunctional monomer;
the composition for preparing the polymer electrolyte further comprises fluoroethylene carbonate (FEC), and the content of fluoroethylene carbonate (FEC) is from 2 to 7 parts by weight based on 100 parts by weight of the total of the cationic monomer and the multifunctional monomer; and
the polymerization is performed at 65 to 78° C. for 2.5 to 4 hours.
